(19) United States
(12) Patent Application Publication
(10) Pub. No.: US 2005/0212720 A1
(43) Pub. Date: Sep. 29, 2005

(54) System and method for computing privacy

(76) Inventors: Michael A. Rothman, Olympia, WA (US); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/813,536

(22) Filed: Mar. 29, 2004

(51) Int. Cl. G09G 5/00

(52) U.S. Cl. 345/8

(57) ABSTRACT

A method and computing system working on and/or viewing materials on a computing system in a private manner in a public environment, such as an internet café, a school, common carrier, etc. The computing system is capable of operating in a privacy mode by utilizing a human display interface which allows the user to view displayed material from a computing device while substantially excluding other people from being able to view the material.

### FIELD

Privacy computing systems.

### BACKGROUND

As the use of computing devices (e.g., desktop PC, laptop, palm pilot, PDA, etc.) proliferates, more and more people are using computing devices in a public environment, such as, for example, on a common carrier (e.g., a train, a subway, an airplane, a bus, etc.), in a university computer lab, an internet café or any number of other public places which are capable of accommodating the use of a computing device. There are often times when the person using a computing device in a public environment may wish to work on or view private, confidential and/or sensitive material (e.g., an invention disclosure) without other people being able to “look over their shoulder” while they are using the computing device. However, since many computing devices include or use a relatively large display, it is difficult for a person using a computing device in these locations to keep others from viewing the material displayed on the display of their computing device.

Currently, if people want to protect themselves from others viewing their private, confidential and/or sensitive material in a public environment, they usually have to find a “corner” or other more secluded location where others are less likely to have an opportunity or capability of viewing the computing device's display. Even if a secluded place exists, there is little guarantee that others will not be able to view the material displayed on the computing device's display.

### BRIEF DESCRIPTION OF THE DRAWINGS

Features, aspects, and advantages of the various embodiments will become more thoroughly apparent from the following detailed description, appended claims, and accompanying drawings in which:

FIG. 1 shows a prior art system for working on or viewing display material in a public environment.

FIG. 2 shows one embodiment of a system for working on or viewing material in a private manner in a public environment.

FIG. 3 shows an embodiment of a human interface device.

FIG. 4 shows a block diagram of one embodiment of computer hardware to allow a computing system to operate in a privacy mode.

FIG. 5 shows an embodiment of a flow diagram of a method for the computer hardware of FIG. 4 to operate in a privacy mode.

FIG. 6 shows a block diagram of one embodiment of hardware for a system to operate in a software-controlled privacy mode.

FIG. 7 shows an embodiment of a flow diagram of a method for the computer hardware of FIG. 6 to operate in a software-controlled privacy mode.

### DETAILED DESCRIPTION

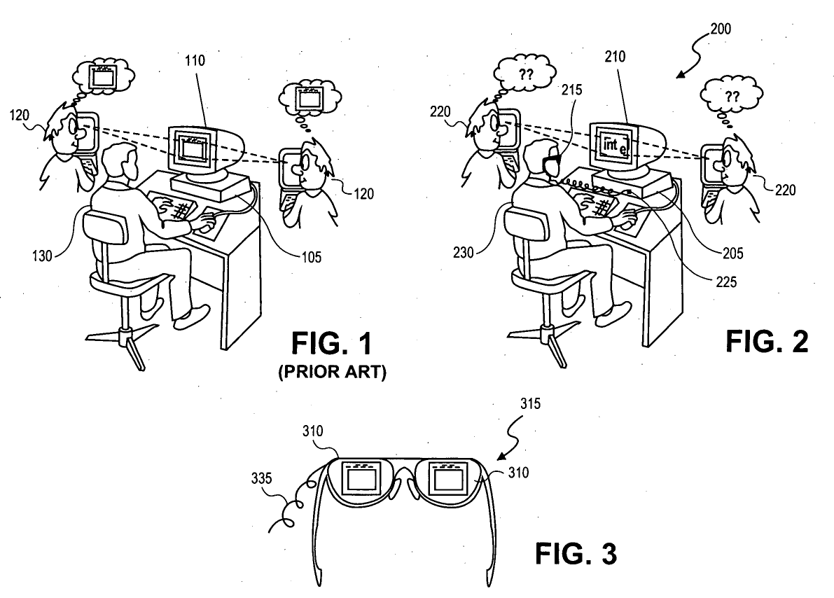

FIG. 1 shows a prior art system for working on or viewing display material on a computing device in a public environment. In this example, computing device 105 is a desktop PC, including display 110 (a desktop monitor in this example). Computing device 105 is also commonly a laptop computer, a PDA, a blackberry, a palm pilot, a word processor or other types of computing device. Generally, each of these computing devices includes a display capable of being viewed by persons 120 other than user 130 while user 130 is using the computing device.

The public environment shown in FIG. 1 is an internet café. In addition, other common public environments include, but are not limited to, a school, a business, a store, a mall, a restaurant, a coffee shop, a common carrier (e.g., train, subway, bus, airplane, water ferry, taxi, etc.) or other locations where people use computing devices.

As shown in FIG. 1, user 130 has little, if any, privacy when working on or viewing material on computing device 105 since display 110 is relatively large in size and thus, capable of being seen by any number of people 120 sitting, standing or passing nearby computing device 105. The size, in addition to the “openness” of display 110, is generally what allows people 120 (i.e., people in close proximity to computing device 105) to view the contents displayed on display 110. Therefore, any information displayed on display 110 becomes, in a sense, “public” since several people 120 are likely able to view the contents of display 110, as shown is FIG. 1. Thus, any privacy desired by user 130 is lost or never even established once user 130 decides to begin working on computing device 105 in a public environment.

FIG. 2 shows one embodiment of a system for viewing material in a private manner in a public environment. In FIG. 2, user 230 is using system 200 in a private manner to view material in an internet café similar to the example illustrated in FIG. 1. However, system 200, when operating in a privacy mode (i.e., when the primary display is disabled and a privacy secondary display (e.g., a human interface display (HID)) is enabled) substantially excludes people 220 from viewing the material user 230 is working on and/or viewing.

System 200, in one embodiment, includes computing device 205, including display 210. In FIG. 2, computing device 205 is a desktop PC. Computing device 205 may, in other embodiments, be a laptop computer, a PDA, a blackberry, a palm pilot, a word processor or other type of computing device with a primary display.

In one embodiment, computing device 205 includes a single port 225 for coupling external devices (e.g., an HID) to computing device 215. In other embodiments, computing device 205 includes a plurality of ports 225 for coupling external devices to computing device 215. Port 225, in one embodiment, is a universal serial bus (USB) port (e.g., USB 2.0). In other embodiments, port 225 may be an IEEE 1394; a red, green, blue (RGB) connection; a digital visual interface (DVI) connection or other type of port capable of being physically coupled to an external device.

Port 225, in other embodiments, is a wireless transmitter capable of “coupling” external devices to computing device 205 by wireless connection. For example, the external device (e.g., HID) may use radio frequency (RF), infrared (IR), bluetooth, optical signals or other methods of wireless communication to couple the external device to port 225.

In one embodiment, port 225 is a high speed video port. Other embodiments may include other port types provided the port is capable of streaming video.

Port 225, in one embodiment, forms an intelligent interface capable of determining what type of device is coupled to port 225. In one embodiment, port 225 is capable of automatically detecting the insertion of an external device. In another embodiment, port 225 sends a prompt to the display informing a user when an external device has been coupled to port 225 and inquires whether the external device is, for example, a privacy device.

In the embodiment shown in FIG. 2, port 225 is located proximate to a front portion (i.e., the portion relatively closest to where user 230 would normally be located when using computing device 205) of computing device 205. In other embodiments, port 225 may be located in other locations on computing device 205. Port 225 should, however, be located in an area accessible by user 230 with relative ease and/or capable of being in communication with a wireless external device.

In an embodiment, system 200 also includes HID 215. In the embodiment shown in FIG. 2, HID 215 is a pair of video glasses. In other embodiments, HID 215 may be video goggles or other display devices capable of allowing the user to view video display material while excluding other people from viewing the material displayed on the device.

As depicted in FIG. 2, people 220 are substantially unable to view the video display material output by computing device 205 once system 200 begins operating in privacy mode. In one embodiment, system 200 begins automatically operating in privacy mode once HID 215 is coupled to port 225. In other embodiments, system 200 operates in privacy mode after HID 215 is coupled to port 225 and user 230, after being prompted, indicates that he/she would like system 200 to operate in privacy mode. System 200, in an embodiment, includes, for example, a pull down menu such that the user is able to select whether he/she would system 200 to operate in privacy mode.

Once system 200 begins operating in privacy mode, in one embodiment, display 210 is disabled (i.e., no longer displays the video display material output by computing device 205). In one embodiment, when disabled, display 210 displays a splash screen in place of the material user 230 wishes to work on and/or view. In the example shown in FIG. 2, the splash screen shown is the Intel® corporate logo. In other embodiments, the splash screen may be other material (e.g., pictures, screen savers, etc.) so long as display 210 does not display the material being worked on and/or viewed by user 230.

Display 210 when disabled, in one embodiment, displays a blank screen (i.e., the screen is “blacked out” or empty) once system 200 begins operating in privacy mode. In other embodiments, when display 210 is disabled, display 210 does not receive a video signal from a video driver contained within computing device 205 and is thus, temporarily no longer utilized.

FIG. 3 shows one embodiment of an HID. In FIG. 3, HID 315 is a pair of video glasses. In one embodiment, HID 315 includes display 310 to display video display data received from, for example, computing device 205 discussed above in reference to FIG. 2.

In one embodiment, HID 315 also includes link 335. Link 335, in one embodiment, is a cable capable of transmitting video display data from the computing device to HID 315.

Link 335, in one embodiment, includes a coupling mechanism (not shown) to be plugged into a video port (e.g., port 225). In one embodiment, the coupling mechanism is a USB connector. In other embodiments, the coupling mechanism may be an IEEE 1394 connector, an RGB connector, a DVI connector or other type of connector capable of being physically coupled to a video port of a computing device. In addition, the coupling mechanism may be a wireless receiver (e.g., RF receiver, IR receiver, optical receiver, etc.) for establishing a wireless connection between HID 315 and a transmitter contained within the computing device.

Display 310 receives video display data from the computing device via link 335 or a wireless connection and displays the video display data to the user of HID 315. The video display data displayed on display 310, in one embodiment, may be private, confidential, sensitive material and/or other material the user wishes to work on and/or view in a public environment without others being substantially capable of viewing. For example, the data displayed on display 310 includes, but is not limited to, a motion picture DVD, a wording processing document, a game, or other material capable of being displayed by a computing device on display 310 (or its equivalent).

In other embodiments, HID 315 may be video goggles operable in a similar manner as the video glasses discussed above. In addition, it is contemplated that HID 315 may be any device known in the art which is capable of displaying video display data in a manner that allows the user of HID 315 to view the displayed data-without allowing others to substantially view the displayed data.

Once HID 315 is coupled to the computing device and the system begins operating in privacy mode, the user is able to, in one embodiment, place HID 315 on his/her head in a manner similar to regular glasses/goggles to view video play data output by the computing device. Once the user has placed HID 315 in the appropriate position, the user is able to view the displayed video data via display 310. In other words, display 310 will display the video data material in a manner similar to a standard display device. The difference, of course, is that only the person using HID 315 is capable of viewing the material displayed on display 310.

In this manner, a user is capable of working on and/or viewing, for example, a word processing document using a keyboard and/or a mouse in a manner similar to what is currently being practiced except that the user views the displayed video data via HID 315 instead of the primary display device (e.g., a monitor, laptop screen, etc.). In addition, the user is also capable of using HID 315, in one embodiment, to display other types of video display material (e.g., the internet) in a manner similar to what a user would normally use a computing device's primary display.

In other embodiments, link 335 also includes a plug to couple a second privacy HID to HID 315. In these embodiments, more than one person is capable of viewing a computing device's output video display data, but people other than the users of these two HIDs are substantially incapable of viewing the display material.

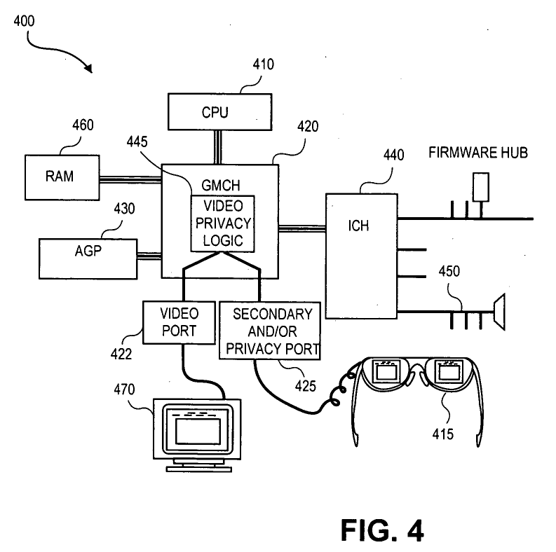

FIG. 4 shows a block diagram of one embodiment of hardware included in a computing device to allow a system to operate in privacy mode. Hardware 400, in one embodiment, includes central processing unit (CPU) 410. CPU 410 may be any processor known in the art capable of allowing, for example, system 200 to operate in privacy mode.

Hardware 400 also includes, in one embodiment, graphics memory control hub (GMCH) 420 coupled to CPU 410. In one embodiment, GMCH 420 provides the host bridge interfaces, has an integrated graphics device with display interfaces and advanced power logic to manage the flow of data between the different interfaces (i.e., processor front side bus, memory attached to an SDRAM controller, accelerated graphics port (AGP), hub interface, CSA interface and video ports 422, 425) of hardware 400. In addition, GMCH 420, in one embodiment, supports data coherency via “snooping” and performs address translation for access to memory contained within, for example, AGP 430.

In an embodiment, GMCH 420 includes video privacy logic 445 (discussed in greater detail below) to allow system 200 to operate in privacy mode. In other embodiments, GMCH 420 also includes multiple queues and a write cache to increase system performance during privacy mode operation.

In one embodiment, hardware 400 also includes AGP 430. AGP 430, in one embodiment is a high speed interface connected to GMCH 420 and uses RAM 460 to refresh an image displayed on a display device (e.g., display 310, display 470).

Hardware 400, in an embodiment, also includes I/O controller hub (ICH) 440. In the embodiment shown in FIG. 4, ICH 440 is connected to GMCH 420 and other buses 450 (e.g., PCI, USB, LPC, etc.), to control the I/O of, for example, computing device 205. In one embodiment, ICH 440 is capable of automatically detecting the insertion of HID 315 into port 425. Once detected, in one embodiment, ICH 440 automatically sends a signal to GMCH 420 to disable (e.g., stop sending display data, send blank screen data, send splash screen data, send screen saver data, etc.) primary display 470 and begin sending video display data to HID 415 via port 425. In embodiments where the buses connecting hardware 400 have limited bandwidth (e.g., USB 1.1), CPU 410 may be leveraged to do fairly aggressive MPEG2/4 video compression of the data being sent to HID 415.

In one embodiment, once primary display 470 is disabled, GMCH 420 enables HID 415 by sending video display data to HID 415 via port 425. At this time, with primary display 470 disabled and video display data being sent to HID 415, the user is able to work on and/or view material in a public environment with relative privacy (i.e., without others being able to see the materials).

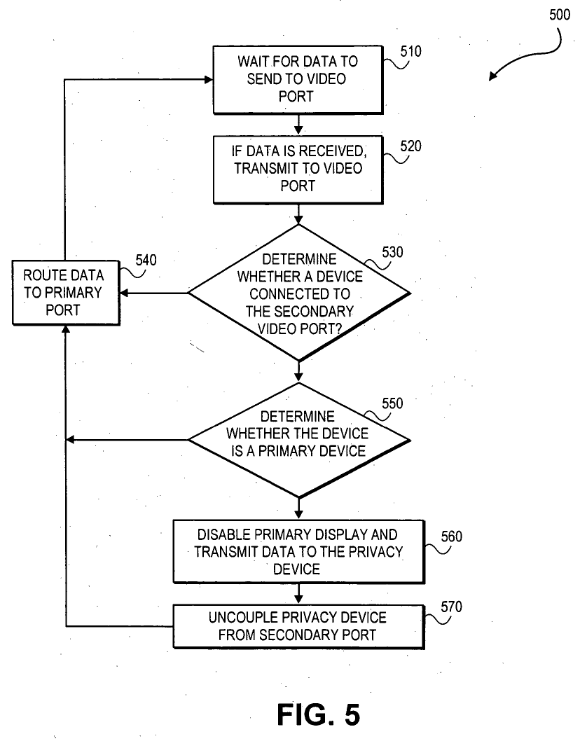

FIG. 5 shows a flow diagram of one embodiment of a method for the hardware of FIG. 4 to operate in a privacy mode. Method 500, in an embodiment, initially waits for data to send to a video port (block 510). Once data is received, in one embodiment, the data is transmitted to a video port (block 520).

In an embodiment, once the data is received at the video port, the video port determines whether there is a HID coupled to the port (block 530). If the port determines there is not an HID coupled to the port, in one embodiment, the data is routed to the primary display to be displayed (block 540) and the system again waits for data to send to the video port (block 510).

If the port determines there is a HID coupled to the port, in one embodiment, the port determines whether the HID is a privacy HID (block 550). In one embodiment, if the HID is not a privacy device, the data is routed to the primary display (block 540) and the system again waits for data to send to the video port (block 510).

In one embodiment, if the port determines the HID is a privacy HID, the primary display is disabled in a manner similar to any of the embodiments discussed above and the data is sent to the privacy HID (block 560). Once the privacy HID is removed from the video port (block 570), the system again waits for data to send to the video port (block 510).

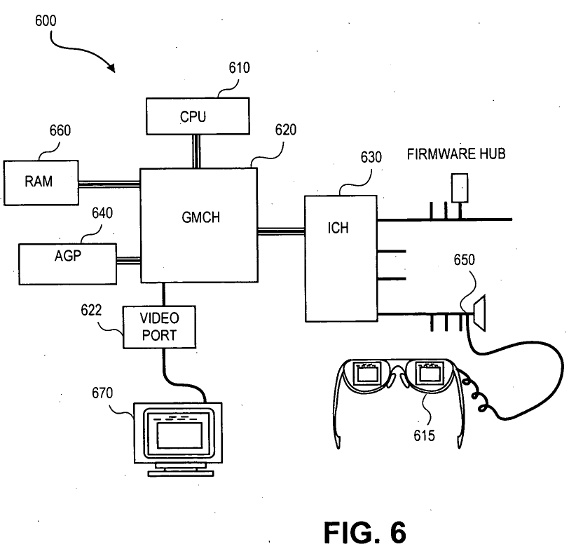

FIG. 6 shows a block diagram of one embodiment of hardware for a system to operate in a software-controlled privacy mode. Hardware 600, in one embodiment, includes CPU 610, GMCH 620, ICH 630, AGP 640 and RAM 660 similar to CPU 510, GMCH 520, ICH 530, AGP 540 and RAM 560 discussed above, respectively.

In one embodiment, a privacy mode of a computing system (e.g. system 200) is performed by software. In one embodiment, software in conjunction with hardware 600 is capable of determining whether HID 615 is a privacy device when HID 615 is coupled to peripheral terminal 650. Once the software detects that HID 615 is a privacy device, the software sends a signal to GMCH 620 to disable primary display 670 in a manner similar to the hardware embodiments discussed above.

In an embodiment, once HID 615 is inserted into peripheral terminal 640, the user is prompted whether HID 615 is a privacy HID. If the user responds in the affirmative, the system begins operating in privacy mode by disabling primary display 670 similar to the embodiments discussed above and enabling HID 615 similar to the embodiment discussed above via peripheral terminal 650. In other embodiments, the user may be able to instruct the software to have the system operate in privacy mode by making a selection on, for example, a pull down menu.

In other embodiments, upon insertion of HID 615, the software is capable of determining whether HID 615 is a privacy device by, for example, the product identification code. If the software determines HID 615 is a privacy device, in an embodiment, a signal is sent to GMCH 620 instructing GMCH 620 to disable primary display 670 and enable HID 615.

Port 622, in one embodiment, comprises a multi-headed video adapter. Port 622 allows primary display 670 and HID 615 to be coupled to it via a first head and a second head, respectively. In one embodiment, the software functions similar to the embodiments discussed above, however, in these embodiments, the software disables primary display 670 and enables HID 415 via the first head and second head of port 622, respectively, when beginning to operate in privacy mode.

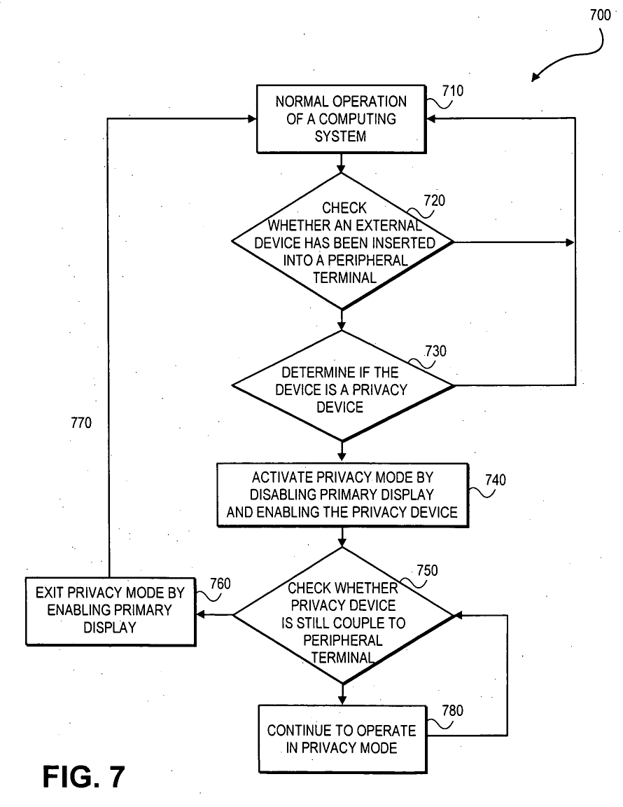

FIG. 7 shows of flow diagram of one embodiment of a method for the hardware of FIG. 6 to operate in a software-controlled privacy mode. Method 700 begins, in one embodiment, with a computing system operating in “normal” mode (block 710). In normal mode, video display data is sent to a primary display and displayed to the user.

In one embodiment, while the computing system is operating in normal mode, software contained within a processor checks whether an external device has been inserted into a peripheral terminal of the computing system (block 720). If an external device has not been inserted, in an embodiment, the computing system continues to operate in normal mode (block 725).

Once the software determines an external device has been inserted into a peripheral terminal, in one embodiment, the software determines whether the external device is a privacy device (block 730). If the peripheral device is not a privacy device, in an embodiment, the computing system continues to operate in normal mode (block 725).

If the software determines the external device is a privacy device, in one embodiment, the software activates the privacy mode of the computing system by disabling the primary display and enabling the external device similar to embodiments discussed above (block 740). In an embodiment, once the computing system is operating in privacy mode, the software check to determine whether the privacy device continues to be coupled to the peripheral terminal (block 750).

In one embodiment, if the software determines the external device has been uncoupled from the peripheral terminal, the system exits privacy mode by enabling the primary display (block 760). With the primary display enabled, in one embodiment, the system returns to operating in normal mode (block 770).

If the software determines that the privacy device remains coupled to the peripheral terminal, in an embodiment, the system continues to operate in privacy mode (block 780). While operating in privacy mode, in one embodiment, the software to periodically check whether the privacy device remains coupled to the peripheral terminal (block 780) until the privacy device is uncoupled from the peripheral terminal (760).

In the preceding paragraphs, specific embodiments are described. It will, however, be evident that various modifications and changes may be made thereto without departing from the broader spirit and scope of the claims. The specification and drawings are, accordingly, to be regarded in an illustrative rather than a restrictive sense.

1. A system comprising:
a computing device including a plurality of ports;
a primary display device coupled to a first port of the computing device;
a human interface device (HID) detachably coupled to a second port of the computing device; and
video privacy logic coupled to the computing device, the first port and the second port to disable the primary display device and route video display data to the HID when the video privacy logic detects a user has coupled the HID to the second port.

2. The system of claim 1, wherein the HID is a privacy device.

3. The system of claim 2, wherein the privacy device comprises:
a head mounted display.

4. The system of claim 3, wherein the head mounted display is one of video glasses and video goggles.

5. The system of claim 1, wherein the HID is coupled to the second video port via one of a universal serial bus (USB) connector, a wireless connection, a digital visual interface (DVI) connector and a red, green, blue (RGB) connector.

6. A system comprising:
a computing device including a plurality of ports;
a primary display device coupled to a first port of the computing device;
an HID detachably coupled to a second port of the computing device; and
a video driver coupled to the computing device, the first port and the second port to disable the primary display device and route video display data to the HID when the video driver detects a user has coupled the HID to the second port.

7. The system of claim 6, wherein the HID is a privacy device.

8. The system of claim 7, wherein the privacy device is a head mounted display.

9. The system of claim 8, wherein the head mounted display is one of video glasses and video goggles.

10. The system of claim 6, wherein the HID is coupled to the second video port via one of a USB connector, a wireless connection, a DVI connector and a RGB connector.

11. The system of claim 6, wherein the first port is a video port and the second port is an auxiliary port.

12. A method comprising:
detecting coupling of a human interface device HID to a port of a computing device;
determining whether the HID is a privacy device; and
disabling a primary display device when the HID is determined to be a privacy device.

13. The method of claim 12, further comprising:
enabling the HID.

14. The method of claim 13, wherein enabling the HID comprises:
sending a signal to a video driver of the computing device to start sending video display data to the HID.

15. The method of claim 12, wherein disabling the primary display device comprises:
sending a signal to a video driver of the computing device to one of stop sending video display data to the primary display device, send blank screen data to the primary driver and send splash screen data to the primary driver such that the primary display device displays a splash screen.

16. The method of claim 12, further comprising:
enabling the primary display device when the privacy device is uncoupled from the port of the computing device.

17. The method of claim 16, wherein enabling the primary display device comprises:
sending a signal to a video driver of the computing device to one of start sending video display data to the primary display device, stop sending blank screen data to the primary display device and stop sending splash screen data to the primary display device.

18. The method of claim 16, further comprising:
monitoring whether the privacy device continues to be coupled to the port.

19. A method, comprising:
coupling an HID to a port of a computing device;
sending video display data to the HID; and
viewing the video display data in a private manner in a public place.

20. The method of claim 19, wherein viewing the video display data in a private manner comprises:
viewing the video display data using one of video glasses and video goggles.

21. The method of claim 19, further comprising:
disabling a primary display of the computing device automatically when the HID is coupled to the port of the computing device.

22. The method of claim 21, further comprising:
enabling the primary display after the HID has been uncoupled from the port.

23. A machine readable medium having instructions stored therein which when executed cause a machine to perform a set of operations comprising:
detecting coupling of a human interface device HID to a port of a computing device;
determining whether the HID is a privacy device; and
disabling a primary display device when the HID is determined to be a privacy device.

24. The machine read medium of claim 23, having further instructions stored therein which when executed cause a machine to perform a set of operations further comprising:
enabling the HID.

25. The machine medium of claim 24, wherein enabling the HID comprises:
sending a signal to a video driver of the computing device to start sending video display data to the HID.

26. The machine medium of claim 23, wherein disabling the primary display device comprises:
sending a signal to a video driver of the computing device to one of stop sending video display data to the primary display device, send blank screen data to the primary driver and send splash screen data to the primary driver such that the primary display device displays a splash screen.

27. The machine readable medium of claim 23, having further instructions stored therein which when executed cause a machine to perform a set of operations further comprising:
enabling the primary display device when the privacy device is uncoupled from the port of the computing device.

28. The machine readable medium of claim 27, having further instructions stored therein which when executed cause a machine to perform a set of operations further comprising:
sending a signal to a video driver of the computing device to one of start sending video display data to the primary display device, stop sending blank screen data to the primary display device and stop sending splash screen data to the primary display device.

29. The machine read medium of claim 27, having further instructions stored therein which when executed cause a machine to perform a set of operations further comprising:
monitoring whether the privacy device continues to be coupled to the port.
